(19) United States
(12) Patent Application Publication
(10) Pub. No.: US 2015/0293290 A1
(43) Pub. Date: Oct. 15, 2015

(54) ILLUMINATION DEVICE, DISPLAY DEVICE, AND TELEVISION RECEIVER DEVICE

(71) Applicant: SHARP KABUSHIKI KAISHA, Osaka (JP)

(72) Inventor: Takashi Ogino, Osaka (JP)

(73) Assignee: Sharp Kabushiki Kaisha, Osaka (JP)

(21) Appl. No.: 14/439,332

(22) PCT Filed: Oct. 30, 2013
(86) PCT No.: PCT/JP2013/079361

§ 371 Date: Apr. 29, 2015

(30) Foreign Application Priority Data
Nov. 6, 2012 (JP) 2012-244302

(51) Int. Cl. F21V 8/00; H04N 9/31; G02F 1/1335

(52) U.S. Cl. CPC G02B 6/005; G02B 6/0088; G02F 1/133514; H04N 9/315

(57) ABSTRACT

The present invention provides a backlight device, including: LEDs; a frame-shaped interior frame that has a sheet-supporting surface; locking members, each including: an upright portion that extends up from the supporting surface in the front side direction, and a bent portion that extends, from the end of the upright portion, away from the center of the frame member and parallel to the supporting surface; and an optical sheet that applies an optical effect to light from the LEDs and includes: openings that are formed in the edges of the optical sheet and through which the upright portions can be inserted, and flexible portions that extend from the edges of the openings such that at least a portion of each flexible portion overlaps with the bent portion of the corresponding locking member in a plan view. The edges of the optical sheet are supported by the supporting surface, and the flexible portions can bend in the direction in which the upright portions extend.

### TECHNICAL FIELD

The present invention relates to an illumination device, a display device, and a television receiver device.

### BACKGROUND ART

In many liquid crystal display devices such as those used in liquid crystal televisions, for example, the liquid crystal panel (the display panel) is not self-luminescent, and therefore a backlight device must be provided separately as an illumination device. These backlight devices can be categorized into direct-lit backlight devices and edge-lit backlight devices depending on the illumination mechanism employed. In both direct-lit and edge-lit backlight devices, an optical sheet is generally used to apply an optical effect to the light emitted from the light source towards the display surface side of the display device (such as making that light planar).

In backlight devices provided with such an optical sheet, a frame-shaped frame member that has a supporting surface for supporting the edges of the optical sheet is generally also provided. Typically, locking members are formed on the supporting surface of the frame member. These locking members are then inserted through openings formed in the edges of the optical sheet in order to lock the optical sheet in place. Patent Document 1, for example, discloses a backlight device of this type.

### RELATED ART DOCUMENT

### Patent Document

Patent Document 1: Japanese Patent Application Laid-Open Publication No. 2002-196312

### Problems to be Solved by the Invention

In backlight devices in which the edges of the optical sheet are fixed to the chassis of the device using locking members formed therein, the locking members typically each include: an upright portion that extends up from the supporting surface; and a claw-shaped bent portion that extends from the end of the upright portion outwards away from the center of the optical sheet. However, if the edges of the optical sheet expand outwards (that is, away from the center of the optical sheet) due to thermal expansion or the like, the bent portions of the locking members can become uncoupled from the openings, resulting in the optical sheet separating from the locking members.

### SUMMARY OF THE INVENTION

The technology disclosed in the present specification was developed in view of such problems. The present specification aims to provide a technology with which the edges of the optical sheet can be locked in place using locking members and separation of the optical sheet from the locking members due to thermal expansion of the optical sheet can be inhibited or prevented.

### Means for Solving the Problems

The technology disclosed in the present specification is an illumination device, including: a light source; a frame-shaped frame member that has at least a supporting surface; locking members, each including an upright portion that extends up from the supporting surface in a direction opposite to a side on which the light source is disposed, and a bent portion that extends, from an end of the upright portion, away from a center of the frame member and parallel to the supporting surface; and an optical sheet that has an edge thereof supported by the supporting surface and that applies an optical effect to light from the light source, the optical sheet having openings that are formed in the edge thereof through which the upright portions of the respective locking members are inserted, and flexible portions that extend from edges of the openings such that at least part of each flexible portion overlaps with the bent portion of the corresponding locking member in a plan view, the flexible portions being flexible in a direction in which the upright portions extend.

In illumination devices in which the edges of an optical sheet are locked in place using locking members, the edges of the optical sheet can expand outwards away from the center of the optical sheet due to heat that is generated when the light source is illuminated. In some cases, this can result in the openings formed in the edges of the optical sheet becoming uncoupled from the upright portions of the locking members. In the present illumination device, flexible portions are formed in the edges of the openings. Moreover, a portion of each flexible portion overlaps with the bent portion of the corresponding locking member when viewed in a plan view. Therefore, even if the portions of the openings that face the upright portions of the locking members shift to a position in which the openings no longer overlap with the bent portions due to thermal expansion of the edges of the optical sheet, at least a portion of each flexible portion remains overlapping with the corresponding bent portion when viewed in a plan view. As a result, even if the edges of the optical sheet undergo thermal expansion, the flexible portions can still come into contact with the bent portions, thereby keeping the optical sheet coupled to the locking members. Therefore, even if the edges of the optical sheet undergo thermal expansion, separation of the optical sheet from the locking members can be inhibited or prevented. Furthermore, the flexible portions can bend in the direction in which the upright portions extend, and therefore the locking members can be inserted through the openings because the bent portions temporarily bend the flexible portions out of the way. As described above, in the present illumination device, using the locking members to lock the edges of the optical sheet in place allows separation of the optical sheet from the locking members due to thermal expansion of the optical sheet to be inhibited or prevented.

Among the edges of the openings, the flexible portions may extend from a location that overlaps with the bent portion of the corresponding locking member in a plan view.

In this configuration, the flexible portions extend along a plane parallel to the plane along which the bent portions extend. This increases the area of each flexible portion that overlaps with the corresponding bent portion when viewed in a plan view. This allows the flexible portions to be locked in place effectively using the locking members.

An indentation may be formed in each upright portion on a side of the upright portion that faces the corresponding flexible portion, and each of the indentations may follow a shape of an end of the corresponding flexible portion.

In this configuration, the flexible portions extend along a plane parallel to the plane along which the bent portions extend, and the end of each flexible portion fits into the interior region of the corresponding indentation. The flexible portion can be shifted towards the upright portion by a distance equal to the depth of the indentation, and therefore the openings can be shifted towards the center of the optical sheet by that same amount. This allows the width of the supporting surface to be reduced and the edge regions of the illumination device to be made thinner.

The openings may be formed in each edge of the four-sided optical sheet

This makes the optical sheet less prone to separation from the frame member regardless of the overall orientation of the illumination device. Therefore, the present illumination device is suitable for use in digital signage or the like.

Protrusion-shaped tabs that extend away from a center of the optical sheet may be formed along edges of the optical sheet, and the openings may be formed in the respective tabs.

In this configuration, only portions of the periphery of the optical sheet are locked in place. Therefore, the occurrence of wrinkling near the openings when the optical sheet deforms due to thermal expansion or the like can be reduced in comparison with a configuration in which the tab portions are not provided.

Each of the upright portions may be orthogonal to the supporting surface, and each of the bent portions may be orthogonal to the corresponding upright portion.

In this configuration, the locking members are less likely to uncouple from the openings than in a configuration in which the bent portions are each arranged at an obtuse angle relative to the corresponding upright portion. Moreover, in this configuration it is easier to insert the locking members through the openings than in a configuration in which the bent portions are each arranged at an acute angle relative to the corresponding upright portion.

The locking members may be elastically deformable.

This makes it easy to lock the optical sheet in place by elastically deforming the locking members to insert those locking members through the openings of the optical sheet during the method for manufacturing the illumination device.

The abovementioned illumination device may further include: a light guide plate having at least one side face as a light-receiving face, and one surface as a light-exiting surface, the light guide plate being arranged such that the light-receiving face thereof faces a light-emitting surface of the light source and such that the light-exiting surface of the light guide plate faces a sheet surface of the optical sheet with a prescribed gap maintained therebetween.

A display device that includes the abovementioned illumination device and a display panel for displaying images using light from the illumination device is an application of the technology disclosed in the present specification that exhibits both an inventive step and technical utility.

In the abovementioned display device, the display panel may be disposed on a side opposite to the supporting surface, with the optical sheet therebetween, and the frame member may further include a panel-supporting surface that supports edges of the display panel.

This configuration allows the frame-shaped supporting member to also function as a support for the display panel without having to provide a separate supporting member therefor.

In the abovementioned display device, the display panel may be supported by the panel-supporting surface such that a gap is maintained between the display panel and the optical sheet.

This is advantageous because if the display panel is layered directly on top of the optical sheet, the optical sheet is more prone to warping due to pressure applied to the sheet surface of the optical sheet by the surface of the display panel. In this configuration, a gap is maintained between the optical sheet and the display panel, and therefore warping of the optical sheet due to the display panel can be prevented.

A display device in which a liquid crystal panel that uses a liquid crystal material is used for the display panel is an application of the technology disclosed in the present specification that exhibits both an inventive step and technical utility. Moreover, a television receiver provided with the abovementioned display device exhibits an inventive step and technical utility.

### Effects of the Invention

The present specification provides a technology with which the edges of the optical sheet can be locked in place using locking members and separation of the optical sheet from the locking members due to thermal expansion of the optical sheet can be inhibited or prevented.

### BRIEF DESCRIPTION OF THE DRAWINGS

FIG. 1 is an exploded perspective view of a television receiver TV according to Embodiment 1.

FIG. 2 is an exploded perspective view of a liquid crystal display device 10.

FIG. 3 is a cross-sectional view taken along one of the short sides of the liquid crystal display device 10.

FIG. 4 is a cross-sectional view taken along the other short side of the liquid crystal display device 10.

FIG. 5 is an enlarged cross-sectional view of a portion of the liquid crystal device 10 shown in FIG. 3 near a locking member 24.

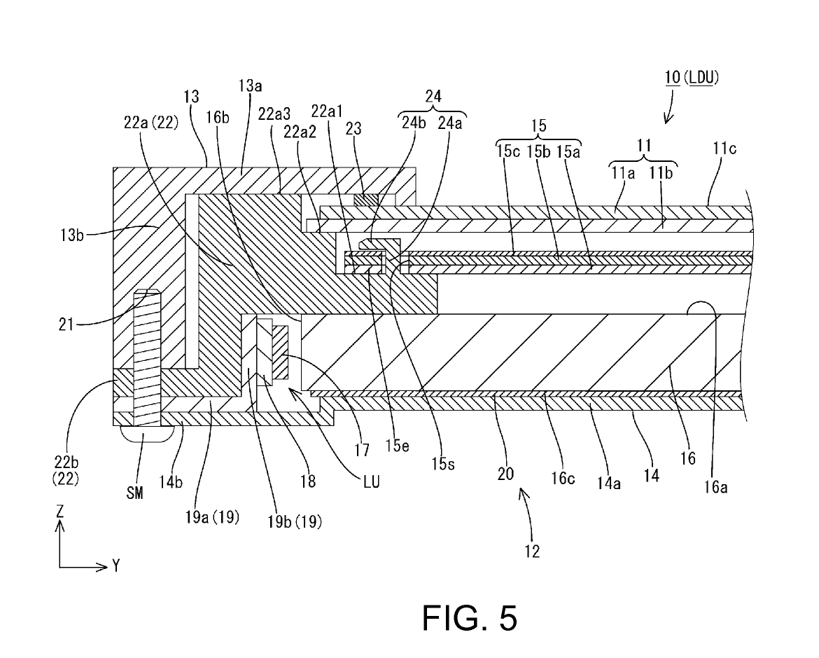

FIG. 6 is a front plan view of an optical sheet 15 locked in place on an interior frame 22.

FIG. 7 is a front side perspective view of an area near a locking member 24.

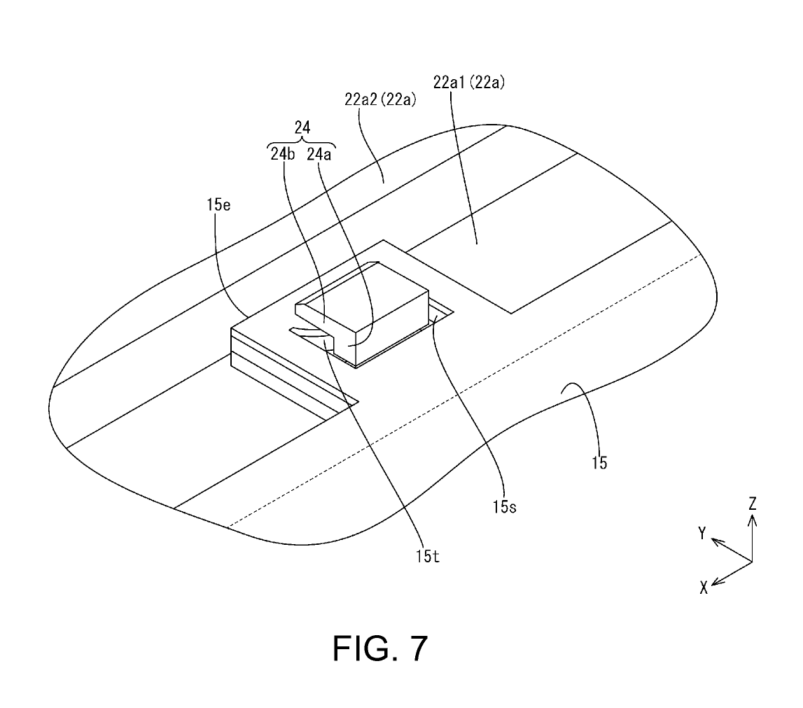

FIG. 8 is a front plan view of an opening 15s formed in the optical sheet 15.

FIG. 9 is a front plan view of an opening of the optical sheet 15 through which a locking member 24 has been inserted.

FIG. 10 is an enlarged cross-sectional view of an area near a locking member 24.

FIG. 11 is an enlarged cross-sectional view of an area near a locking member 24 after the optical sheet 15 has undergone thermal expansion.

FIG. 12 is an enlarged cross-sectional view of an area near a locking member 24 illustrating how a flexible portion 151 bends.

FIG. 13 is a perspective view of a locking member 124 according to Embodiment 2.

FIG. 14 is a front plan view of an area near an opening 115s of an optical sheet 115 through which a locking member 124 has been inserted.

FIG. 15 is a front plan view of an opening 215s formed in an optical sheet 215 according to Embodiment 3.

FIG. 16 is a front plan view of an opening 315s formed in an optical sheet 315 according to Embodiment 4.

### DETAILED DESCRIPTION OF EMBODIMENTS

### Embodiment 1

Embodiment 1 will be described below with reference to figures. In the present embodiment, a liquid crystal display device 10 is used as an example of a display device. The X, Y, and Z axes are illustrated in each figure and are common to each figure (that is, the X, Y, and Z axes point in the same directions in each figure). Here, the Y direction is the vertical direction, and the X direction is the horizontal direction. Moreover, “up” and “down” refer to the vertical direction unless specifically noted otherwise.

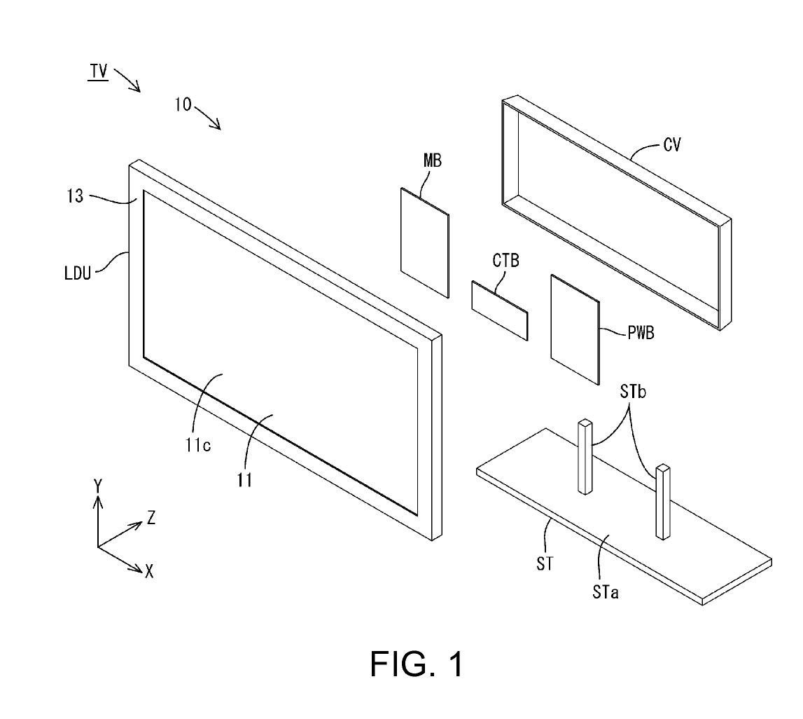

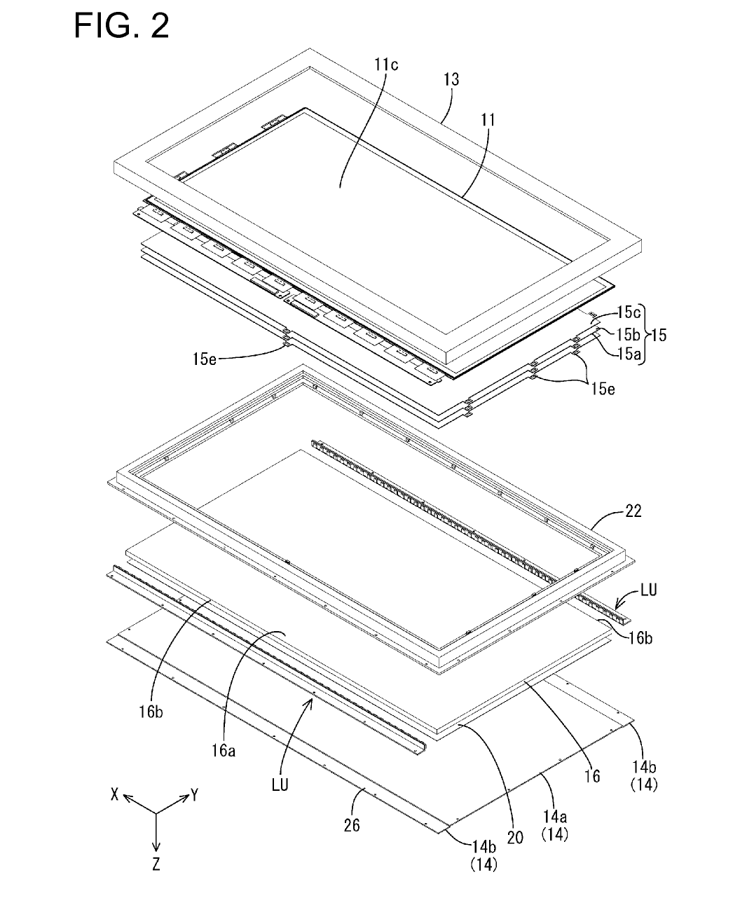

As shown in FIG. 1 a television receiver TV of the present embodiment includes: a liquid crystal display unit LDU; several circuit boards PWB, MB, and CTB disposed on the rear side of the liquid crystal display unit LDU, a cover CV that is disposed on the rear side of the liquid crystal display unit LDU and covers the circuit boards PWB, MB, and CTB; and a stand ST. The stand ST supports the liquid crystal display unit LDU such that the display surface thereof is substantially parallel to the Y direction (the vertical direction). The liquid crystal display device 10 of the present embodiment is equivalent to the television receiver TV not including at least the parts that receive television signals (a tuner of the main board MB or the like). As shown in FIG. 2, the liquid crystal display unit LDU has a horizontally elongated rectangular shape and includes: a liquid crystal panel 11 (an example of a display panel) that has a display surface 11c for displaying images; a backlight device 12 (an example of an illumination device) that serves as an external light source; and an exterior frame 13 provided on the front side (that is, the display surface 11c-side) of the liquid crystal panel 11 such that the liquid crystal panel 11 is sandwiched between the exterior frame 13 and the backlight device 12. The exterior frame 13 and a chassis 14 of the backlight device 12 are both exterior members and together form the exterior of the liquid crystal display device 10. It should be noted that the chassis 14 of the present embodiment is both an exterior member of the overall liquid crystal display device 10 and a member of the backlight device 12.

Next, the configuration of the stand ST, the cover CV, and the circuit boards PWB, MB, and CTB of the liquid crystal display device 10 will be described. The stand ST includes: a base STa that has sides parallel to X and Z directions; and a pair of struts STb that extend upwards in the Y direction from the base STa. The cover CV is made of a synthetic resin and covers a portion of the rear surface of the chassis 14. A component housing space that can house components such as the circuit boards PWB, MB, and CTB is maintained between the cover CV and the chassis 14. The circuit boards PWB, MB, and CTB include a power board PWB, a main board MB, and a control board CTB. The power board PWB serves as the power supply for the liquid crystal display device 10. The power board PWB supplies power to drive the other boards MB and CTB, LEDs (an example of a light source) of the backlight device 12, and the like. Therefore, the power board PWB doubles as the LED driving board (light source driving board/power supply) that drives the LEDs 17. The main board MB includes a tuner that can receive television signals and an image processing unit that processes the television signals that are received (neither the tuner nor the image processing unit are shown in the figures). The processed image signals are then output to the control board CTB. Moreover, when the liquid crystal display device 10 is connected to an external image reproduction device (not shown in the figures), the liquid crystal display device 10 takes image signals that are input from that image reproduction device. The main board MB can process those input image signals in the image processing unit and output the processed image signals to the control board CTB. The control board CTB converts image signals input from the main board MB to liquid crystal drive signals and sends those converted liquid crystal drive signals to the liquid crystal panel 11.

As shown in FIG. 2, the primary components of the liquid crystal display unit LDU of the liquid crystal display device 10 are housed in the space between the exterior frame 13 (which forms the front side of the exterior of the liquid crystal display unit LDU) and the chassis 14 (which forms the rear side of the exterior of the liquid crystal display unit LDU). The primary components housed in the space between the exterior frame 13 and the chassis 14 include at least: the liquid crystal panel 11, an optical sheet 15, a light guide plate 16, an interior frame 22 (an example of a frame member), and LED units LU. The liquid crystal panel 11 and the optical sheet 15 are sandwiched between the exterior frame 13 (on the front side) and the interior frame 22 (on the rear side), with the liquid crystal panel 11 arranged on top of the optical sheet 15. Meanwhile, the light guide plate 16 is sandwiched between the interior frame 22 (on the front side) and the chassis 14 (on the rear side). The backlight device 12 includes the light guide plate 16, the interior frame 22, the LED unit LU, and the chassis 14. The backlight device 12 is equivalent to the liquid crystal display unit LDU not including the liquid crystal panel 11, the optical sheet 15, and the exterior frame 13. The LED units LU of the backlight device 12 are arranged between the interior frame 22 and the chassis 14, with the LED units LU sandwiching the light guide plate 16 in the short side direction thereof (that is, in the Y direction/vertical direction) from both sides. That is, the arrangement of the LED units LU (LEDs 17) coincides with the edges of the light guide plate 16 in the Y axis direction. Each component will be described in more detail below.

As shown in FIGS. 2 to 4, the liquid crystal panel 11 has a horizontally elongated rectangular shape when viewed in a plan view. The liquid crystal panel 11 includes: a pair of glass substrates 11a and 11b that exhibit excellent transparency and are fixed to one another with a prescribed gap maintained therebetween; and a liquid crystal material sealed between the substrates 11a and 11b. The front side substrate is the color filter (CF) substrate 11a, and the rear side substrate is the array substrate 11b. The array substrate 11b includes: a plurality of source lines and gate lines that are mutually orthogonal to one another; a plurality of switching elements (TFTs, for example) that are connected to the source lines and the gate lines; a plurality of pixel electrodes connected to the switching elements; an alignment film; and the like. Meanwhile, the color filter substrate 11a includes: a color filter that includes a plurality of colored members in colors such as red (R), green (G), and blue (B); an opposite electrode; an alignment film; and the like. Moreover, polarizing plates (not shown in the figures) are provided on the outward-facing surfaces of the substrates 11a and 11b.

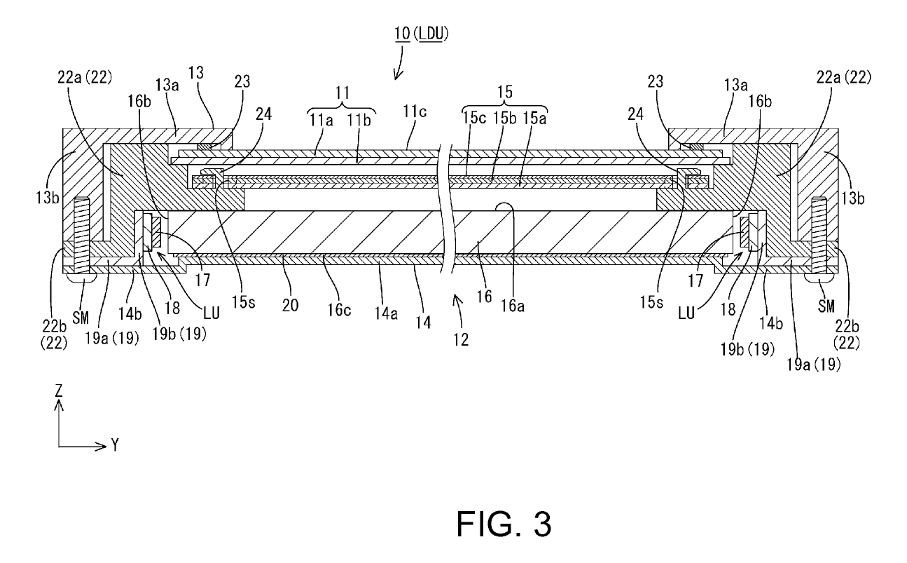

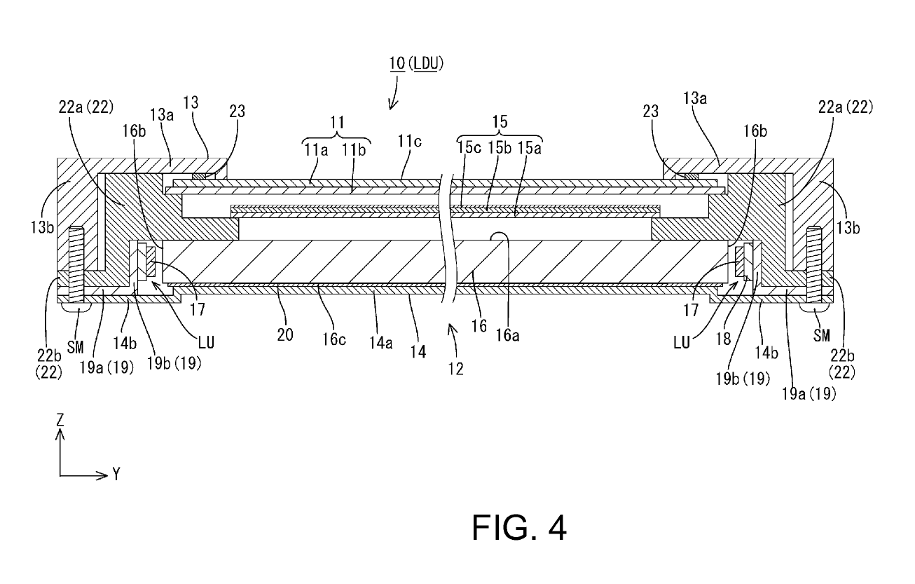

As shown in FIGS. 3 and 4, the array substrate 11b of the liquid crystal panel 11 is larger than the color filter substrate 11a when viewed in a plan view. The edges of the array substrate 11b extend outwards past the edges of the color filter substrate 11a. More specifically, the outer peripheral edges of the array substrate 11b extend outwards past the outer peripheral edges of the color filter substrate 11a around the entire periphery thereof. Along the long edges of the array substrate 11b, a plurality of terminals are drawn out from the gate lines and source lines. These terminals are connected to a driver for driving the liquid crystal layer. The driver is mounted on a flexible substrate. Signals from the control board CTB are sent to each terminal via the flexible substrate in order to display images on the display surface 11c of the liquid crystal panel 11.

The exterior frame 13 is made from a metal such as aluminum, which gives the exterior frame 13 higher mechanical strength (rigidity) and thermal conductivity than a synthetic resin, for example. As shown in FIG. 3, the exterior frame 13 has a horizontally elongated frame shape that frames the display region of the display surface 11c of the liquid crystal panel 11. The exterior frame 13 includes: a panel guard portion 13a that runs parallel to the display surface 11c of the liquid crystal panel 11 and covers the periphery of the liquid crystal panel 11 from the front side; and a sidewall 13b that extends out from the rear side of the panel guard portion 13a around the outer periphery thereof. The exterior frame 13 has a substantially L-shaped cross section. The panel guard portion 13a has a horizontally elongated frame shape that follows the outer periphery of the liquid crystal panel 11 (the non-display region/bezel region) and covers essentially the entire outer periphery of the liquid crystal panel 11 from the front side. Moreover, a cushioning member 23 is provided between the panel guard portion 13a and the liquid crystal panel 11. Like the display surface 11c of the liquid crystal panel 11, the outer surface of the panel guard portion 13a that faces outwards in the front side direction of the liquid crystal display device 10 is exposed. Together, the display surface 11c of the liquid crystal panel 11 and the exposed portion of the panel guard portion 13a form the exterior of the front side of the liquid crystal display device 10. Meanwhile, the sidewall 13b extends out from the rear side of the panel guard portion 13a around the outer periphery thereof and has a substantially rectangular prismatic shape. The sidewall 13b encloses the backlight device 12 around the entire periphery thereof. The outer surface of the sidewall 13b that runs around the entire periphery of the liquid crystal display device 10 is exposed and forms the top end face, bottom end face, and side end faces of the liquid crystal display device 10.

As shown in FIGS. 3 and 4, screw holes 21 are formed in the rear side surface of the sidewall 13b to accept screw members SM that are inserted from the rear side. A plurality of screw holes 21 are formed intermittently in the rear surface of the sidewall 13b. The screw holes 21 are arranged in lines that run along the corresponding sides of the sidewall 13b. The sidewall 13b is fixed to the chassis 14 with the interior frame 22 sandwiched therebetween using screw members SM that are inserted through the chassis 14 from the rear side.

Next, each component of the backlight device 12 will be described. Each LED unit LU includes: a heat sink 19, an LED substrate 18, and LEDs 17. Each heat sink 19 is made from a metal that exhibits excellent thermal conductivity, such as aluminum for example. As shown in FIG. 2, each heat sink 19 runs along one of the long sides of the light guide plate 16 (that is, in the X direction). The length of the heat sinks 19 is approximately equal to the length of the long sides of the light guide plate 16. Each heat sink 19 has a substantially L-shaped cross section. Each heat sink 19 includes: a bottom portion 19a that runs along the surface of the chassis 14; and a mounting portion 19b on which the LED substrate 18 is mounted and which extends from the bottom portion 19a towards the light-exiting surface 16a side (that is, towards the front side) of the light guide plate 16 such that the mounting portion 19b faces the light-receiving face 16b of the light guide plate 16.

The bottom portion 19a of the heat sink 19 is plate-shaped, with the long side being parallel to the X direction, the short side being parallel to the Y direction, and the thickness direction being parallel to the Z direction. The outer edge of the bottom portion 19a (that is, the edge on the side of the bottom portion 19a opposite to the side on which the light guide plate 16 is disposed) is sandwiched between the interior frame 22 and the chassis 14. Moreover, the bottom portion 19a is fixed to the sidewall 13b of the exterior frame 13 by the screw members SM that go through the bottom portion 19a. Essentially the entire surface of the bottom portion 19a that faces the front surface of the chassis 14 (that is, the rear surface of the bottom portion 19a) is fixed to the chassis 14 using a fixing member such as double-sided tape or an adhesive agent. As a result, the majority of the heat transmitted into the heat sinks 19 is radiated away from the liquid crystal display device 10 via the chassis 14. The mounting portion 19b of each heat sink 19 is also plate-shaped, with the surface of the mounting portion 19b running in the X and Z directions. In other words, the mounting portion 19b runs along parallel to the light-receiving face 16b of the light guide plate 16, with a prescribed gap maintained between the mounting portion 19b and the light-receiving face 16b. The mounting portion 19b of each heat sink 19 is also plate-shaped, with the long side being parallel to the X direction, the short side being parallel to the Z direction, and the thickness direction being parallel to the Y direction. The mounting portion 19b extends out in the Z direction from the outer edge of the bottom portion 19a. The LED substrate 18 is mounted on the inner surface of the mounting portion 19b (that is, on the surface that faces the light guide plate 16).

As shown in FIG. 2, the LED substrate 18 is a long, narrow plate that runs in the long side direction of the chassis 14 (that is, in the X direction). The surface of the LED substrate 18 runs in the X and Z directions; that is, the surface of the LED substrate 18 is orthogonal to the surfaces of the liquid crystal panel 11 and the light guide plate 16. The LED substrate 18 is housed within the chassis 14. A prescribed gap is maintained between the LED substrate 18 and the light guide plate 16. An LED substrate 18 is provided along both long sides of the light guide plate 16 (that is, along the light-receiving faces 16b), and each LED substrate 18 is mounted to the inner surface of the mounting portion 19b of the corresponding heat sink 19. The inner surface of the LED substrate 18 (that is, the surface that faces the light guide plate 16) is the mounting surface on which the LEDs 17 are surface-mounted. A plurality of LEDs 17 are mounted on the mounting surface of each LED substrate 18 in a straight line that runs in the X direction and with a prescribed interval left between each individual LED 17. The gap between adjacent LEDs 17 in the X direction (that is, the pitch of the arrangement of LEDs 17) is essentially uniform throughout the LED arrangement. A wiring pattern (not shown in the figures) that is made from a metal film (such as copper foil) and runs in the X direction is formed on the mounting surface of each LED substrate 18 to connect the LEDs 17 in series. Terminals are formed on both ends of the wiring pattern, and these terminals are connected to an external LED drive circuit that provides power to drive the LEDs 17.

Each LED 17 includes an LED chip (not shown in the figures) that is sealed to the corresponding LED substrate 18 using a resin material. The LED chips mounted on the LED substrates 18 emit light of primarily one wavelength. More specifically, the LED chips emit a single color of blue light. Meanwhile, a fluorescent material that is excited by the blue light emitted from the LED chips and emits light of a prescribed color is dispersed in the resin material used to seal the LED chips. Overall, the LED chip-resin material assemblies emit primarily white light. It should be noted that an appropriate combination of a yellow fluorescent substance that emits yellow light, a green fluorescent substance that emits green light, and a red fluorescent substance that emits red light or any single one of these fluorescent substances can be used for the fluorescent material. These LEDs 17 are so-called top-emitting LEDs in which the light-emitting surface of each LED 17 is the surface opposite to the mounting surface of the corresponding LED substrate 18.

The light guide plate 16 is made from a synthetic resin material (such as an acrylic resin such as polymethyl methacrylate (PMMA) or a polycarbonate, for example) that has a refractive index that is sufficiently higher than that of air and is also substantially transparent (exhibits excellent transparency). As shown in FIG. 2, similar to the liquid crystal panel 11 and the chassis 14, the light guide plate 16 has a horizontally elongated rectangular shape when viewed in a plan view. The light guide plate 16 is plate-shaped and has a thickness greater than the thickness of the optical sheet 15. The long sides of the surface of the light guide plate 16 are parallel to the X direction, and the short sides of the surface of the light guide plate 16 are parallel to the Y direction. The thickness direction of the light guide plate 16 is orthogonal to the surface of the light guide plate 16 and parallel to the Z direction. As shown in FIGS. 3 and 4, the light guide plate 16 is arranged between the pair of LED units LU, with the light-emitting surface 16a (the primary surface, the front surface) facing the optical sheet 15 and the opposite surface 16c (that is, the (rear) surface that is opposite to the light-exiting surface 16a) facing a reflective sheet 20. The light guide plate 16 is supported by the chassis 14 with the reflective sheet 20 sandwiched therebetween. In other words, the light guide plate 16 is arranged between the LED units LU in the Y direction and between the optical sheet 15 and the reflective sheet 20 in the Z direction. The light emitted from the LED units LU in the Y direction enters the end faces of the long sides of the light guide plate 16 (that is, the light-receiving faces 16b). The light guide plate 16 spreads that light throughout the interior of the light guide plate 16 and then emits it from the light-exiting surface 16a towards the optical sheet 15.

The reflective sheet 20 has an elongated rectangular shape. The reflective sheet 20 is made from a synthetic resin, and a white color that exhibits excellent reflectivity is applied to the surface of the reflective sheet 20. The long sides of the reflective sheet 20 are parallel to the X direction, and the short sides of the reflective sheet 20 are parallel to the Y direction. The reflective sheet 20 is sandwiched between the opposite surface 16c of the light guide plate 16 and the front surface of the chassis 14. The front surface of the reflective sheet 20 is the reflective surface and contacts the opposite surface 16c of the light guide plate 16. Furthermore, the reflective surface of the reflective sheet 20 reflects light that escapes from the LED units LU or the light guide plate 16.

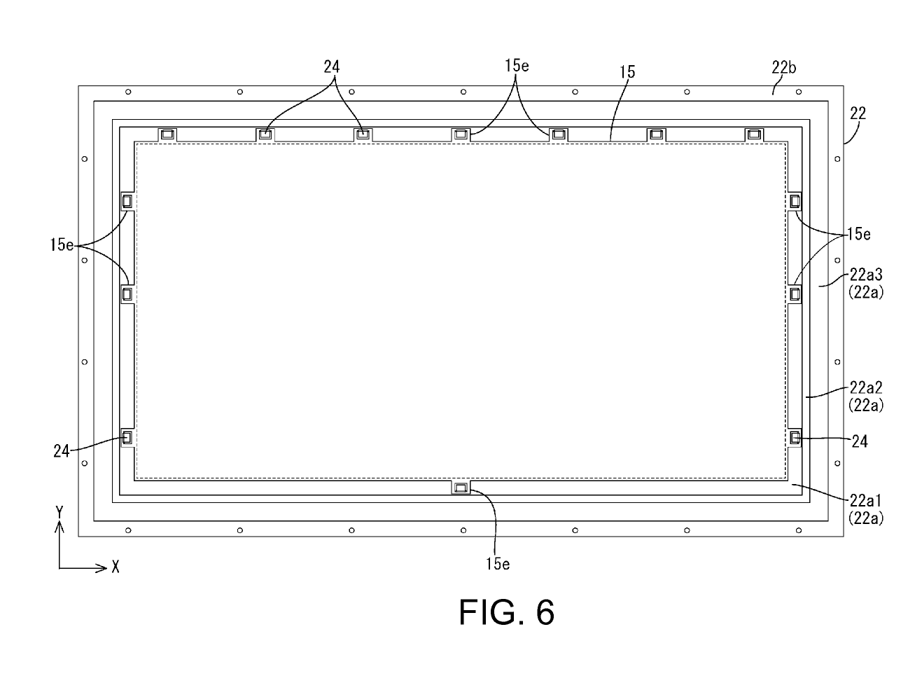

As shown in FIG. 2, similar to the liquid crystal panel 11 and the chassis 14, the optical sheet 15 has a horizontally elongated rectangular shape when viewed in a plan view. The optical sheet 15 includes a diffusion sheet 15a, a lens sheet 15b, and a reflective polarizing plate 15c, which are layered in order starting from the side on which the light guide plate 16 is disposed. The optical sheet 15 is arranged between the liquid crystal panel 11 and the light guide plate 16 such that the optical sheet 15 transmits light emitted from the light guide plate 16 towards the liquid crystal panel 11 and also applies a prescribed optical effect to that transmitted light. A small gap is maintained between the optical sheet 15 and the liquid crystal panel 11. Moreover, the optical sheet 15 is bigger in both the X and Y directions than an opening formed by a frame-shaped supporting portion 22a of the interior frame 22. The outer edges of the optical sheet 15 are supported by a sheet-supporting surface 22a1 of the interior frame 22. As shown in FIG. 3, the spaces between the LED units LU and the light guide plate 16 are separated from the edges of the optical sheet 15 by the interior frame 22. When viewed in a plan view, the optical sheet 15 is smaller in both the X and Y directions than the liquid crystal panel 11. As shown in FIGS. 2 and 6, a plurality of tab portions 15e that extend outwards beyond the edges of the liquid crystal panel 11 are formed along the edges of the optical sheet 15. The tab portions 15e will be described in more detail later.

As shown in FIG. 2, the interior frame 22 has a horizontally elongated frame shape similar to the shape of the exterior frame 13. Moreover, the interior frame 22 is made from a synthetic resin. The interior frame 22 includes: a frame-shaped supporting portion 22a that supports the optical sheet 15 and the liquid crystal panel 11; and a flange-shaped flange portion 22b that extends outwards from the outer periphery of the frame-shaped supporting portion 22a. The inner perimeter of the frame-shaped supporting portion 22a of the interior frame 22 is substantially stair-shaped and has three different levels. The frame-shaped supporting portion 22a runs around the periphery of the light guide plate 16. The optical sheet 15 and the light guide plate 16 are arranged on the rear side of the frame-shaped supporting portion 22a, which covers essentially the entire peripheries of the optical sheet 15 and the light guide plate 16 from the front side. Moreover, the long sides of the frame-shaped supporting portion 22a cover both the light-receiving face 16b-side edges of the light guide plate 16 and the LED units LU from the front side. The flange portion 22b of the interior frame 22 extends outwards beyond the outer end faces of the frame-shaped supporting portion 22a. The long sides of the flange portion 22b are parallel to the X direction, the short sides of the flange portion 22b are parallel to the Y direction, and the thickness direction of the flange portion 22b is parallel to the Z direction. The outer edges of the flange portion 22b are sandwiched between the sidewall 13b of the exterior frame 13 and the bottom portions 19a of the heat sinks 19. The flange portion 22b is fixed to the sidewall 19b using the screw members SM that go through the flange portion 22b.

The frame-shaped supporting portion 22a has three different levels. The lowest level (the sheet-supporting surface 22a1 (an example of a supporting surface)) supports essentially the entire periphery of the optical sheet 15 from the rear side thereof. In other words, the sheet-supporting surface 22a1 is disposed between the optical sheet 15 and the light guide plate 16. Moreover, a plurality of claw-shaped locking members 24 for locking the optical sheet 15 in place are formed in the sheet-supporting surface 22a1. The configuration of the locking members 24 will be described in more detail later. The second lowest level (the panel-supporting surface 22a2) of the frame-shaped supporting portion 22a supports essentially the entire periphery of the liquid crystal panel 11 from the rear side thereof. Here, the height above the sheet-supporting surface 22a1 at which the panel-supporting surface 22a2 is provided is greater than the thickness of the optical sheet 15. As a result, as shown in FIGS. 3 and 4, the liquid crystal panel 11 is supported by the panel-supporting surface 22a2, and a small gap is maintained between the optical sheet 15 and the liquid crystal panel 11. The highest level (the frame-supporting surface 22a3) of the frame-shaped supporting portion 22a contacts the inner surface of the panel guard portion 13a of the exterior frame 13, thereby supporting the exterior frame 13 from the inside.

Next, the chassis 14 will be described. The chassis 14 is made from a metal such as aluminum, which gives the chassis 14 higher mechanical strength (rigidity) and thermal conductivity than a synthetic resin, for example. As shown in FIG. 3, the chassis 14 includes: a plate-shaped first plate portion 14a that covers essentially all of the light guide plate 16 and the reflective sheet 20 from the rear side; and plate-shaped second plate portions 14b that are arranged on both long edges of the first plate portion 14a, are offset slightly from the first plate portion 14a in the rear direction, and extend outwards. Both the first plate portion 14a and second plate portions 14b of the chassis 14 are exposed on the rear side, forming the rear side of the exterior of the liquid crystal display device 10. The front surface of the first plate portion 14a of the chassis 14 contacts essentially all of the rear surface of the reflective sheet 20. The reflective sheet 20 is sandwiched between the first plate portion 14a and the opposite surface 16c of the light guide plate 16. The first plate portion 14a supports the opposite surface 16c of the light guide plate 16 from the rear side via the reflective sheet 20. Sandwiching the reflective sheet 20 between the light guide plate 16 and the chassis 14 in this way inhibits or prevents warping of the reflective sheet 20 due to transmission of heat thereto. Moreover, the second plate portions 14b of the chassis 14 cover both the light-receiving face 16b-side edges of the light guide plate 16 and the LED units LU from the rear side. The outer edges of the front surfaces of the second plate portions 14b contact the entire rear surfaces of the bottom portions 19a of the corresponding heat sinks 19. The bottom portions 19a of the heat sinks 19 are sandwiched between the flange portion 22b of the interior frame 22 and the second plate portions 14b. In the portions of the second plate portions 14b that contact the bottom portions 19a of the corresponding heat sinks 19, screw members SM are inserted from the rear side to fix the chassis 14 to the sidewall 13b of the exterior frame 13.

Next, the configurations of the following primary components of the present embodiment will be described: the tab portions 15e of the optical sheet 15; openings 15s formed in the tab portions 15e; the locking members 24; and flexible portions 151 that extend from the edges of the openings 15s. As shown in FIG. 6, tab portions 15e are formed along each edge of the four-sided optical sheet 15. The tab portions 15e protrude outwards away from the center of the optical sheet 15 (that is, away from the center of the interior frame 22) and are rectangular when viewed in a plan view. Moreover, the tab portions 15e are formed in the same arrangement and with the same shape and size in each of three sheet members 15a, 15b, and 15c of the optical sheet 15. More specifically, three tab portions 15e are formed along both short edges of the optical sheet 15. Moreover, seven tab portions 15e are formed along one long edge of the optical sheet 15 (the upper right edge of the optical sheet 15 in FIG. 2). Finally, one tab portion 15e is formed along the other long edge of the optical sheet 15 (the lower left edge of the optical sheet 15 in FIG. 2). Each tab portion 15e is supported along with the corresponding edge of the optical sheet 15 by the sheet-supporting surface 22a1 of the frame-shaped supporting portion 22a of the interior frame 22.

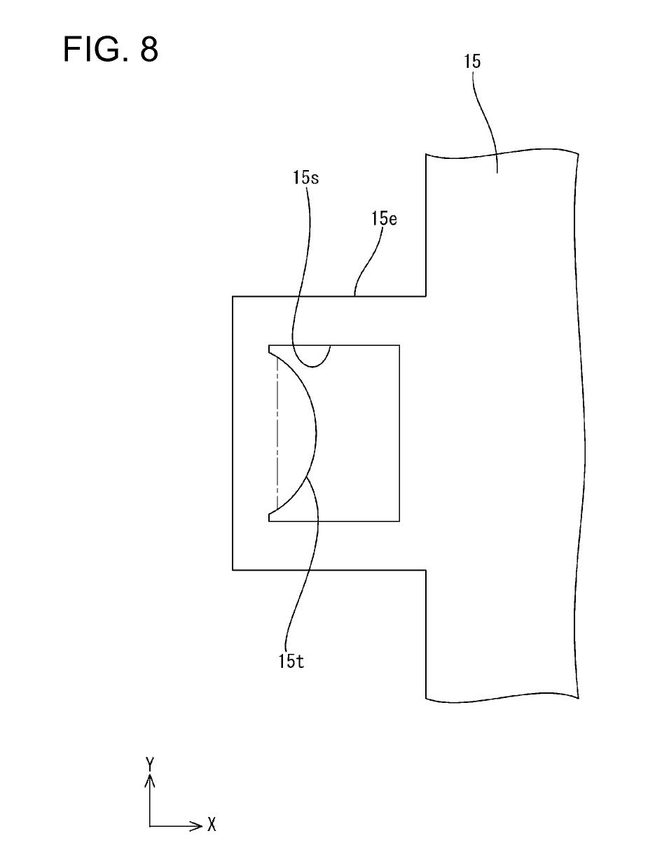

In each tab portion 15e, an opening 15s that goes through the respective tab portion 15e in the thickness direction thereof (that is, in the Z direction) is formed. As shown in FIGS. 6 and 8, each opening 15s is substantially rectangular when viewed in a plan view. Moreover, an arc-shaped flexible portion 151 is formed along one edge of each opening 15s. Like the tab portions 15e, the openings 15s are formed in the same arrangement and with the same shape and size in each of three sheet members 15a, 15b, and 15c of the optical sheet 15.

Meanwhile, as shown in FIGS. 3 and 6, a plurality of claw-shaped locking members 24 are formed in the sheet-supporting surface 22a1 of the frame-shaped supporting portion 22a of the interior frame 22. Each locking member 24 includes: an upright portion 24a that stands up from the sheet-supporting surface 22a1 in the front side direction; and a bent portion 24b that extends outwards from the end of the upright portion 24a. The locking members 24 are capable of elastic deformation. The upright portions 24a of the locking members 24 have an elongated, narrow plate shape with the width direction thereof running parallel to the corresponding edge of the optical sheet 15 when viewed in a plan view. The upright portions 24a extend in the front side direction, are orthogonal to the sheet-supporting surface 22a1, and go through the openings 15s formed in the tab portions 15e. The upright portions 24a go through the openings 15s formed in the tab portions 15e with a gap maintained between the edges of each opening 15s and the edges of each upright portion 24a. As a result, if the tab portions 15e of the optical sheet 15 shift in the sheet surface direction (that is, in the X or Y directions), the upright portions 24a come into contact with the edges of the openings 15s formed in the tab portions 15e, thereby preventing the tab portions 15e from shifting any further in the X or Y directions. Therefore, movement of the optical sheet 15 in the X or Y directions is restricted by the upright portions 24a.

The bent portion 24b of each locking member 24 is plate-shaped and extends orthogonally outwards from the end of the corresponding upright portion 24a The bent portions 24b are parallel to the surface of the optical sheet 15 (that is, parallel to the display surface 11c of the liquid crystal panel 11 and parallel to the Y direction) and extend outwards away from the center of the optical sheet 15 (that is, away from the center of the interior frame 22). The ends of the bent portions 24b end at a position nearer the center of the optical sheet 15 than outer edge of the corresponding tab portions 15e of the optical sheet 15 but do extend outwards past the outer edges of the openings 15s in the corresponding tab portions 15e. In other words, the ends of the bent portions 24b are disposed above the surfaces of the tab portions 15e. As a result, in a state in which the optical sheet 15 is not deformed due to thermal expansion or the like, if the tab portions 15e of the optical sheet 15 begin to move upwards, those tab portions 15e come into contact with the bent portions 24b and are prevented from moving upwards any further. Therefore, movement of the optical sheet 15 in the thickness direction thereof (that is, in the Z direction) is restricted by the bent portions 24b. As described above, the locking members 24 restrict movement of the tab portions 15e of the optical sheet 15 in the X, Y, and Z directions. Moreover, the bent portions 24b are disposed at a height lower than the panel-supporting surface 22a2 that supports the liquid crystal panel 11 (that is, the bent portions 24b are disposed near the sheet-supporting surface 22a1) and extend outwards parallel to the display surface 11c of the liquid crystal panel 11. Therefore, the bent portions 24b do not interfere with the display surface 11c of the liquid crystal panel 11. Moreover, the distance between the bent portions 24b and the optical sheet 15 is less than the thickness of the optical sheet 15. Therefore, even if the optical sheet 15 warps towards the front side direction, the optical sheet 15 will immediately contact the bent portions 24b, thereby inhibiting or preventing uncoupling of the optical sheet 15 from the locking members 24.

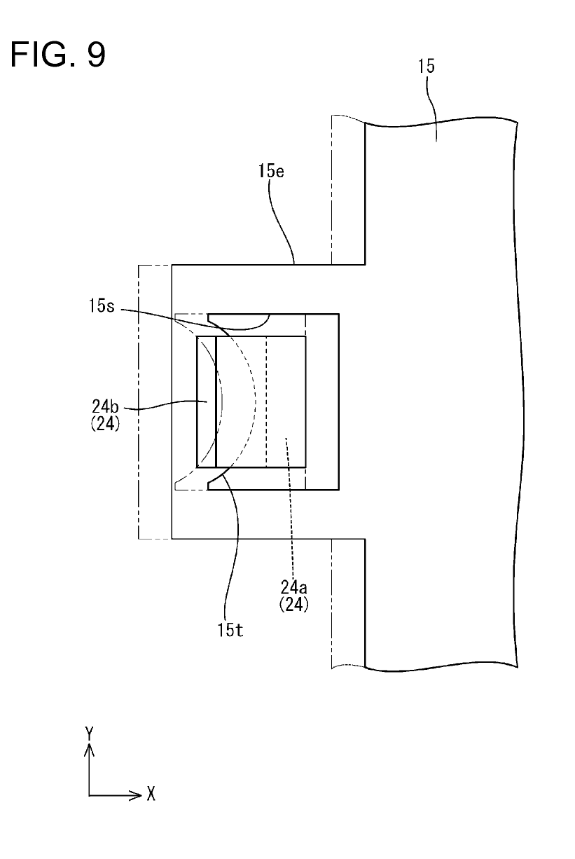

Next, the flexible portions 151 that extend from the edges of the openings 15s formed in the tab portions 15e will be described in more detail. As shown in FIG. 8, each flexible portion 151 is formed in the opening 15s formed in the corresponding tab portion 15e. The flexible portion 151 is formed in the edge of the opening 15s that overlaps with the corresponding bent portion 24b when viewed in a plan view (that is, in the outer edge of the opening 15s that is positioned nearest to the end of the tab portion 15e) and extends towards the upright portion 24a. The flexible portions 151 are part of the optical sheet 15. Each flexible portion 151 has a curved shape that protrudes towards the corresponding upright portion 24a when viewed in a plan view. Therefore, as shown in FIG. 9, a portion of each flexible portion 151 overlaps with the corresponding bent portion 24b when viewed in a plan view. Moreover, the flexible portions 151 can bend in the direction in which the upright portions 24a extend (that is, in the Z direction). Moreover, like the tab portions 15e and the openings 15s, the flexible portions 151 are formed in the same arrangement and with the same shape and size in each of three sheet members 15a, 15b, and 15c of the optical sheet 15.

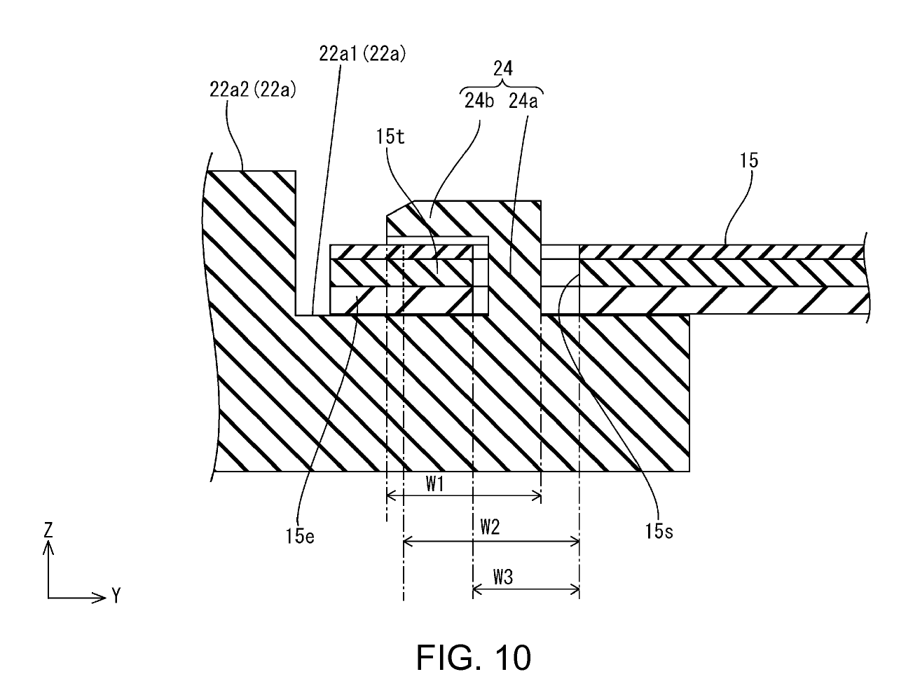

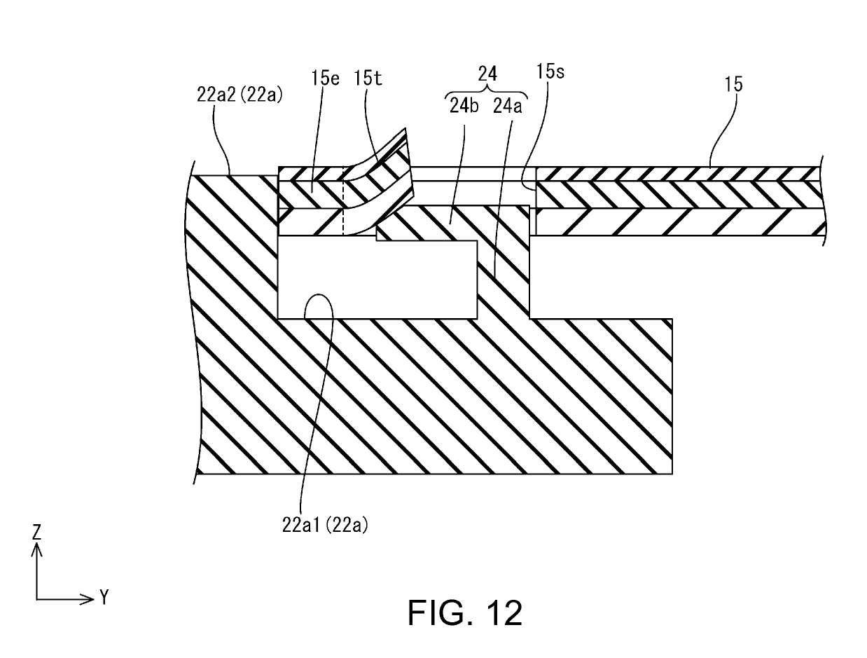

Next, the process by which the optical sheet 15 is locked into place using the locking members 24 formed in the sheet-supporting surface 22a1 of the interior frame 22 during a method for manufacturing the backlight device 12 will be described. As shown in FIG. 10, the length W1 of the bent portion 24b of the locking member 24 is smaller, in the direction in which the bent portion 24b extends (that is, in the Y direction), than the opening width W2 of the opening 15s formed in the tab portion 15e. Meanwhile, the length W1 of the bent portion 24b is greater than the distance W3, where W3 is equal to the opening width W2 minus the length of the flexible portion 151. When coupling the optical sheet 15 with the locking members 24, the tab portions 15e of the optical sheet 15 are brought near the sheet-supporting surface 22a1 from the front side with the tab portions 15e disposed parallel to the sheet-supporting surface 22a1, and the upright portions 24a of the locking members 24 are inserted through the openings 15s formed in the tab portions 15e. As shown in FIG. 12, although the bent portions 24b come into contact with the flexible portions 151 because the length W2 of the bent portions 24b is greater than the distance W3, the bent portions 24b can still be inserted through the openings 15s because the flexible portions 151 bend out of the way in the thickness direction of the optical sheet 15 (that is, in the Z direction) and because the length W2 of the bent portions 24b is less than the opening width W2. In this way, one edge of the optical sheet 15 can be coupled with the locking members 24.

Next, by taking advantage of the gaps between the edges of the openings 15s and the upright portions 24a of the locking members 24, the optical sheet 15 is shifted towards one of the three sides thereof that has not already been coupled with the locking members 24. This makes it possible to overlap the openings 15s of the tab portions 15e with the locking members 24 on a side of the frame-shaped supporting portion 22a of the interior frame 22 on which the optical sheet 15 has not already been coupled to the locking members 24. Next, these overlapping locking members 24 are inserted through the openings 15s of the tab portions 15e using the process described above to couple the optical sheet 15 with the locking members 24 on that side. Finally, the optical sheet 15 is shifted in succession towards the remaining two sides of the frame-shaped supporting portion 22a to which it has not already been coupled, and the process described above is repeated until the locking members 24 are coupled with the optical sheet 15 on all four sides thereof. In this way, the optical sheet 15 can be fixed to the interior frame 22.

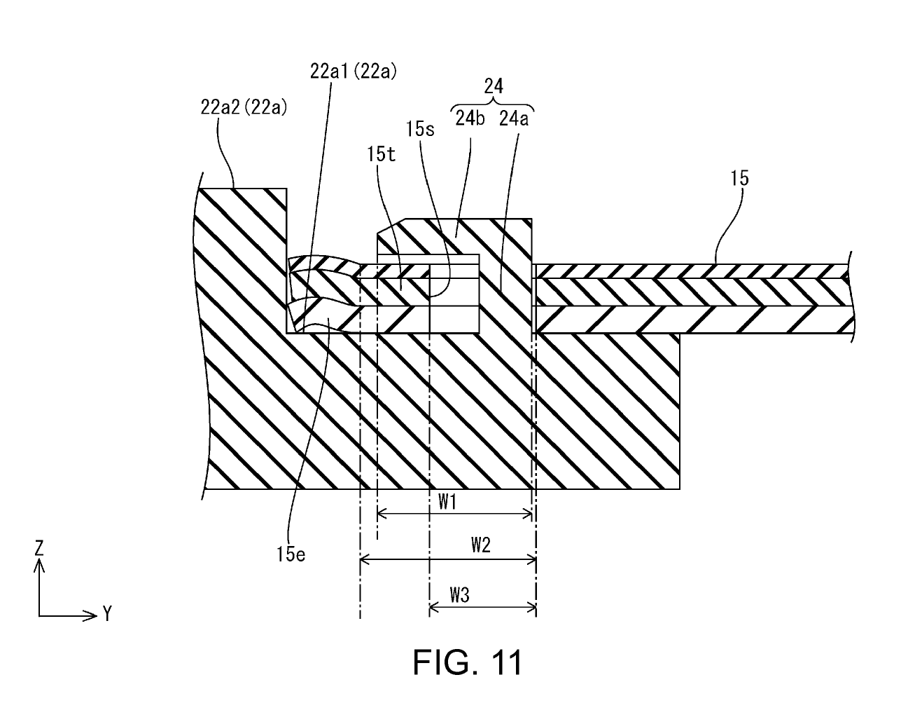

In the backlight device 12 of the present embodiment, the optical sheet 15 undergoes thermal expansion due to heat and the like generated by the LEDs 17. When the optical sheet 15 undergoes thermal expansion, each edge of the optical sheet 15 expands outwards (that is, away from the center of the optical sheet 15). As a result, the tab portions 15e of the optical sheet 15 shift outwards in such a way that the entire bent portions 24b of the locking members 24 overlap with the interior regions of the openings 15s (as shown by the long dashed double-short dashed line in FIG. 9 and as shown in FIG. 11). In this state, each edge of the optical sheet 15 may bend and warp upwards (in the front side direction), thereby causing the tab portions 15e to move away from the sheet-supporting surface 22a1 of the interior frame 22. This may in turn cause the tab portions 15e to uncouple from the locking members 24. In the present embodiment, the flexible portions 151 extend from the edges of the openings 15s towards the locking members 24. Therefore, even if the tab portions 15e of the optical sheet 15 shift outwards, the bent portions 24b of the locking members 24 remain overlapping with the flexible portions 151. As a result, even if the tab portions 15e shift outwards and move away from the sheet-supporting surface 22a1, the flexible portions 151 come into contact with the bent portions 24b of the locking members 24 and prevent the tab portions 15e from warping any further. This inhibits or prevents uncoupling of the tab portions 15e from the locking members 24, thereby inhibiting or preventing separation of the optical sheet 15 from the interior frame 22.

As described above, in conventional backlight devices in which the edges of an optical sheet are locked in place using locking members, the edges of the optical sheet expand outwards away from the center of the optical sheet due to heat that is generated when the LEDs are illuminated. In some cases, this can result in the openings formed in the edges of the optical sheet becoming uncoupled from the upright portions of the locking members. In the backlight device 12 of the present embodiment, flexible portions 151 are formed in the edges of the openings 15s, as described above. A portion of each flexible portion 151 overlaps with the bent portion 24b of the corresponding locking member 24 when viewed in a plan view. Therefore, even if the portions of the openings 15s that face the upright portions 24a of the locking members 24 shift to a position in which the openings 15s no longer overlap with the bent portions 24b due to thermal expansion of the edges of the optical sheet 15, at least a portion of each flexible portion 151 remains overlapping with the corresponding bent portion 24b when viewed in a plan view. As a result, even if the edges of the optical sheet 15 undergo thermal expansion, the flexible portions 151 can still come into contact with the bent portions 24b, thereby keeping the optical sheet 15 coupled to the locking members 24. Therefore, even if the edges of the optical sheet 15 undergo thermal expansion, separation of the optical sheet 15 from the locking members 24 can be inhibited or prevented. Furthermore, the flexible portions 151 can bend in the direction in which the upright portions 24a extend (that is, in the Z direction), and therefore the locking members 24 can be inserted through the openings 15s because the bent portions 24b temporarily bend the flexible portions 151 out of the way. As described above, in the backlight device 12 of the present embodiment, using the locking members 24 to lock the edges of the optical sheet 15 in place allows separation of the optical sheet 15 from the locking members 24 due to thermal expansion of the optical sheet 15 to be inhibited or prevented.

Moreover, in the backlight device 12 of the present embodiment, the flexible portions 151 extend from the edges of the openings 15s that overlap with the bent portions 24b when viewed in a plan view. In this configuration, the flexible portions 151 extend along a plane parallel to the plane along which the bent portions 24b extend. This increases the area of each flexible portion 151 that overlaps with the corresponding bent portion 24b when viewed in a plan view. This allows the flexible portions 151 to be locked in place effectively using the locking members 24.

Moreover, in the backlight device 12 of the present embodiment, the openings 15s are formed in each edge of the four-sided optical sheet 15. Backlight devices such as those used in digital signage may be arranged in a variety of orientations (vertically, horizontally, or the like). This has the potential to cause problems if only one edge of the optical sheet is fixed to the chassis of the backlight device. For example, in a case in which only the bottom edge of the optical sheet is fixed to the backlight device, the weight of the optical sheet itself can cause the optical sheet to shift downwards and become uncoupled from the locking members. In contrast, in the present embodiment, all four edges of the four-sided optical sheet 15 are locked in place using the locking members 24, and therefore the optical sheet 15 is less prone to separation from the interior frame 22 regardless of the orientation of the backlight device 12. As a result, the backlight device 12 of the present embodiment is suitable for use in illumination devices such as those used in digital signage.

Moreover, in the backlight device 12 of the present embodiment, tab portions 15e that protrude away from the center of the optical sheet 15 are formed along each edge of the optical sheet 15. Furthermore, openings 15s through which the locking members 24 can be inserted are formed in the tab portions 15e. In this configuration, only portions of the periphery of the optical sheet 15 are locked in place. Therefore, the occurrence of wrinkling near the openings 15s when the optical sheet 15 deforms due to thermal expansion or the like can be reduced in comparison with a configuration in which the tab portions 15e are not provided.

Moreover, in the backlight device 12 of the present embodiment, the upright portions 24a of the locking members 24 are orthogonal to the sheet-supporting surface 22a1. Furthermore, the bent portions 24b of the locking members are orthogonal to the upright portions 24a. In this configuration, the locking members 24 are less likely to uncouple from the openings 15s than in a configuration in which the bent portions 24b are each arranged at an obtuse angle relative to the corresponding upright portion 24a. Moreover, in this configuration it is easier to insert the locking members 24 through the openings 15s than in a configuration in which the bent portions 24b are each arranged at an acute angle relative to the corresponding upright portion 24a.

Moreover, in the backlight device 12 of the present embodiment, the locking members 24 are capable of elastic deformation. Therefore, the optical sheet 15 can easily be locked in place by elastically deforming the locking members 24 to insert those locking members 24 through the openings 15s of the optical sheet 15 during the method for manufacturing the backlight device 12.

Moreover, the backlight device 12 of the present embodiment is an edge-lit backlight device in which the light-exiting surface 16a of the light guide plate 16 faces the optical sheet 15 and in which a prescribed gap is maintained therebetween. In this configuration, the light emitted from the light-exiting surface 16a of the light guide plate 16 diffuses in an advantageous manner in the space between the light guide plate 16 and the optical sheet 15, thereby allowing a more satisfactory brightness distribution to be achieved.

Moreover, in the backlight device 12 of the present embodiment, the liquid crystal panel 11 is supported by the panel-supporting surface 22a2 of the interior frame 22, thereby maintaining a gap between the liquid crystal panel 11 and the optical sheet 15. This is advantageous because if the liquid crystal panel 11 is layered directly on top of the optical sheet 15, the optical sheet 15 is more prone to warping due to pressure applied to the sheet surface of the optical sheet 15 by the panel surface of the liquid crystal panel 11. In the configuration of the present embodiment, a gap is maintained between the optical sheet 15 and the liquid crystal panel 11, and therefore warping of the optical sheet 15 due to the liquid crystal panel 11 can be prevented.

### Embodiment 2

Embodiment 2 will be described below with reference to figures. Embodiment 2 is different from Embodiment 1 in that an indentation 124a1 is formed in the upright portion 124a of each locking member 124. The other components of the present embodiment are configured the same as in Embodiment 1, and descriptions of the structures, functions, and effects of those components are omitted here.

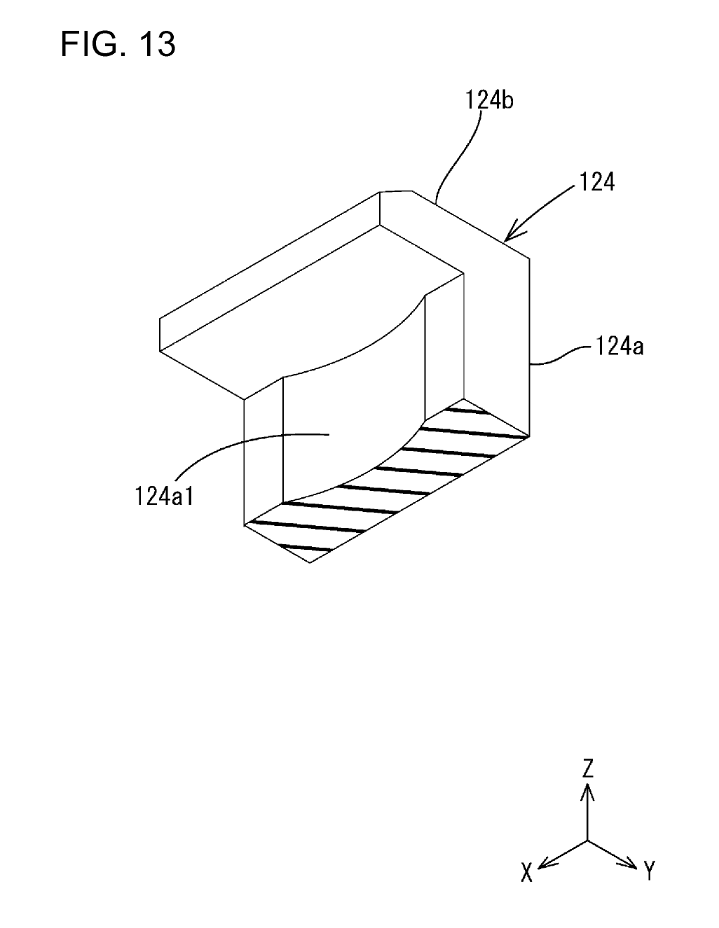

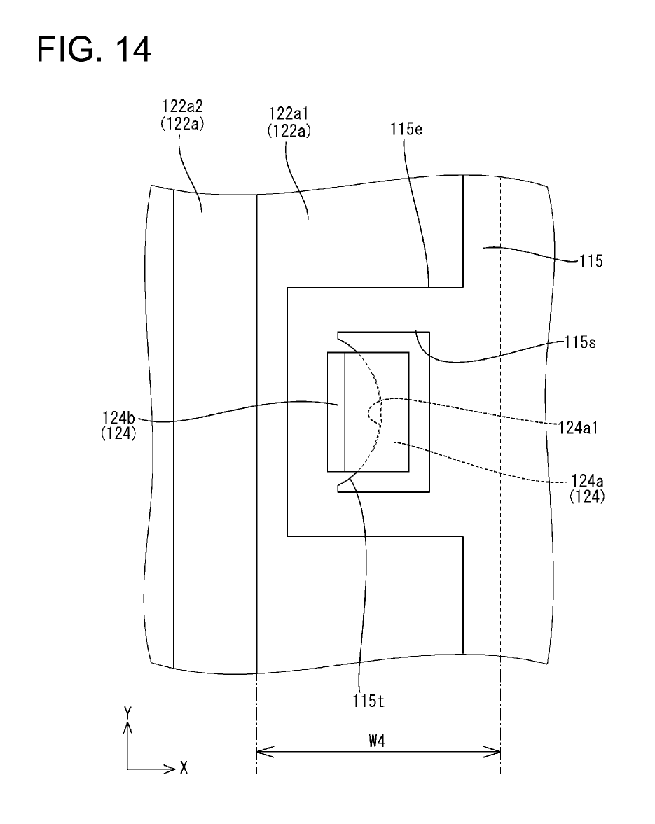

As shown in FIG. 13, in a backlight device according to Embodiment 2, an indentation 124a1 is formed on the inner side of the upright portion 124a of each locking member 124. As shown in FIG. 14, this indentation 124a1 is formed on the side of the upright portion 124a facing the end of a flexible portion 115t and follows the shape thereof. Furthermore, as shown in FIG. 14, when the locking member 124 is inserted through an opening 115s formed in a tab portion 115e, the end of the flexible portion 115t fits into the interior region of the indentation 124a1. When the locking member 124 is inserted through the opening 115s formed in the tab portion 115e, the end of the flexible portion 115t fits into the interior region of the indentation 124a1. The flexible portion 115t can be shifted towards the upright portion 124a by a distance equal to the depth of the indentation 124a1, and therefore the overall opening 115s can be shifted towards the center of an optical sheet 115 by that same amount. In this way, as shown in FIG. 14, the width W4 of the edge of the optical sheet 115 that is supported by a sheet-supporting surface 122a1 can be reduced. Therefore, the edge regions of the backlight device can be made thinner.

### Embodiment 3

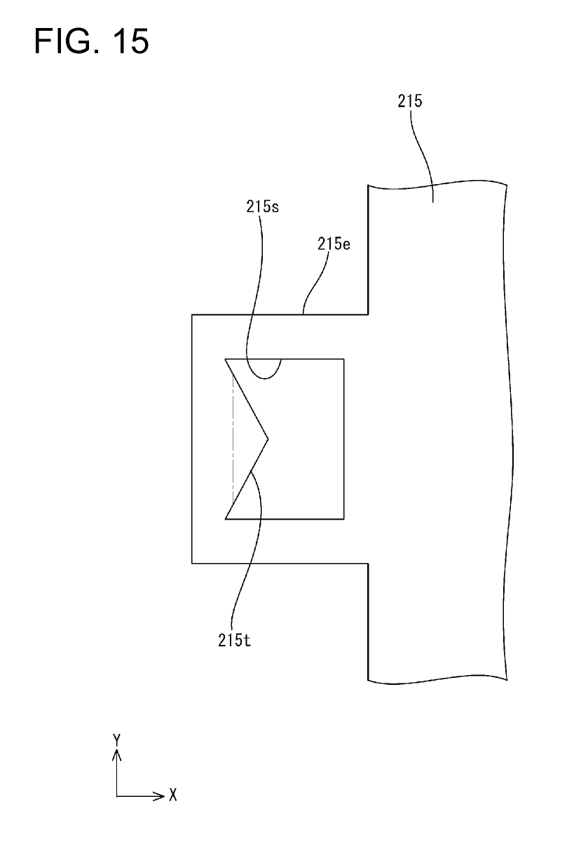

Embodiment 3 will be described below with reference to figures. In Embodiment 3, the shape of a flexible portion 215t that extends from the edge of an opening 215s that is formed in a tab portion 215e of an optical sheet 215 is different than in Embodiment 1. The other components of the present embodiment are configured the same as in Embodiment 1, and descriptions of the structures, functions, and effects of those components are omitted here. Note that in FIG. 15, the components that have a reference character that is exactly 200 more than the reference character of a component in FIG. 9 correspond to the same components used in Embodiment 1.

As shown in FIG. 15, in a backlight device according to Embodiment 3, the flexible portion 215t has a pointed shape and extends toward an upright portion of a locking member. Even when the flexible portion 215t has this shape, a portion of the flexible portion 215t overlaps with a bent portion of the locking member when viewed in a plan view. Therefore, the flexible portion 215t remains overlapping with the bent portion when viewed in a plan view even if the optical sheet 215 undergoes thermal expansion, and separation of the optical sheet 215 from an interior frame can be inhibited or prevented. Moreover, when the flexible portion 215t has this shape, the locking member can still be inserted through the opening 215s by bending the flexible portion 215t out of the way in the thickness direction of the optical sheet 215 (that is, by bending the flexible portion 215t in the Z direction along the dashed line shown in FIG. 15) to lock the optical sheet 215 in place.

### Embodiment 4

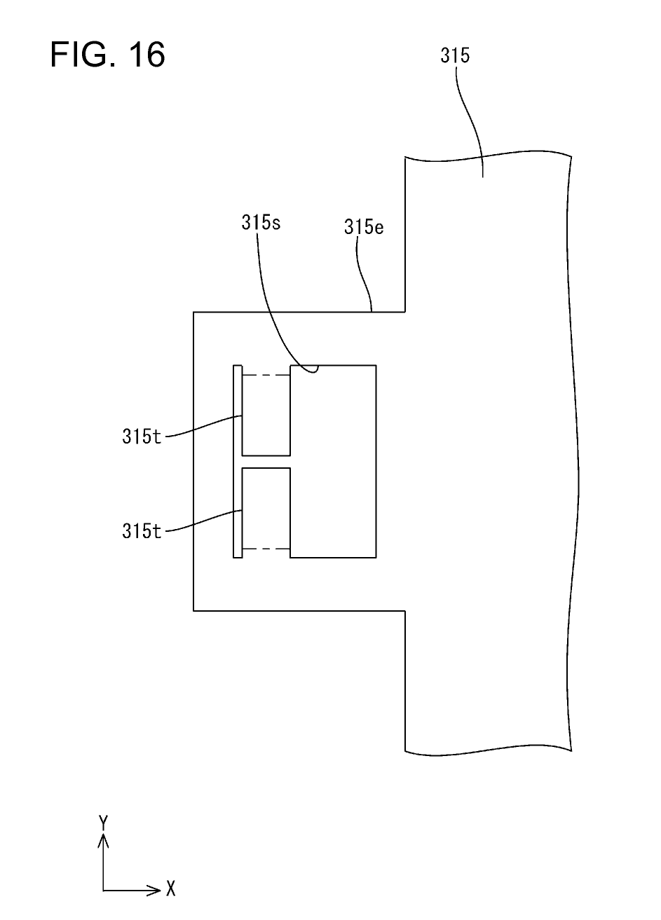

Embodiment 4 will be described below with reference to figures. In Embodiment 4, the shape of flexible portions 315t that extend from the edges of an opening 315s formed in a tab portion 315e of an optical sheet 315 is different than in Embodiment 1. The other components of the present embodiment are configured the same as in Embodiment 1, and descriptions of the structures, functions, and effects of those components are omitted here. Note that in FIG. 16, the components that have a reference character that is exactly 300 more than the reference character of a component in FIG. 9 correspond to the same components used in Embodiment 1.

As shown in FIG. 16, in a backlight device according to Embodiment 4, a pair of flexible portions 315t extend from the edges of the opening 315s. More specifically, the flexible portions 315t are provided on both lateral edges (lateral with respect to the direction in which a bent portion of a locking member extends when viewed in a plan view) of the opening 315s. The flexible portions 315t each have an elongated rectangular shape when viewed in a plan view, and the ends of the flexible portions 315t face one another. Even when the flexible portions 315t have this shape, a portion of each flexible portion 315t overlaps with the bent portion of the locking member when viewed in a plan view. Therefore, the flexible portions 315t remain overlapping with the bent portion when viewed in a plan view even if the optical sheet 315 undergoes thermal expansion, and separation of the optical sheet 315 from an interior frame can be inhibited or prevented. Moreover, when the flexible portions 315t have this shape, the locking member can still be inserted through the opening 315s by bending the flexible portions 315t out of the way in the thickness direction of the optical sheet 315 (that is, by bending the flexible portions 315t in the Z direction along the dashed line shown in FIG. 16) to lock the optical sheet 315 in place.

Next, modification examples of the embodiments will be described.

(1) In the embodiments described above, the flexible portions extend from the edges of the openings that overlap with the bent portions when viewed in a plan view or extend from both lateral edges of the openings in a direction orthogonal to the direction in which the bent portions extend when viewed in a plan view. However, the edges of the openings from which the flexible portions extend are not limited to these examples.

(2) In the embodiments described above, the backlight device is configured for use in a television receiver. However, the backlight device may also be configured for use in other display media such as digital signage.

(3) In the embodiments described above, the backlight device is edge-lit. However, the backlight device may also be direct-lit.

(4) In the embodiments described above, tab portions are formed in the edges of the optical sheet, and then openings are formed in those tab portions. However, openings may be formed directly in the edges of the optical sheet without ever forming tab portions.

(5) In the embodiments described above, the openings are formed in each of the edges of the four-sided optical sheet. However, the openings may also be formed only in any one, two, or three edges of the optical sheet. Moreover, the number of openings formed along an edge of the optical sheet is not limited.

(6) Properties of the openings such the size, shape, arrangement, and number thereof may be changed as appropriate to achieve configurations other than those used in the embodiments described above.

(7) Properties of the flexible portions such the size, shape, arrangement, and number thereof may be changed as appropriate to achieve configurations other than those used in the embodiments described above.

(8) Properties of the locking members such the size, shape, and configuration thereof may be changed as appropriate to achieve configurations other than those used in the embodiments described above.

(9) In the embodiments described above, the liquid crystal display device is not provided with a cabinet. However, the liquid crystal display device may be provided with a cabinet.

(10) In the abovementioned embodiments, liquid crystal display devices in which a liquid crystal panel is used for the display panel were described. However, the present invention may also be applied to display devices in which other types of display panels are used.

Embodiments of the present invention were described in detail above, but these are nothing more than examples and do not limit the scope of the claims in any way. The technology disclosed in the claims also includes a variety of variations and modifications to the specific examples described above.

Moreover, elements of the technology described in the present specification and drawings exhibit technical utility when used either singularly or in combination. The present invention is not limited to the combinations of the technical elements presented in the claims when the present application was filed. Moreover, the technology disclosed in the present specification and drawings simultaneously achieves multiple technical effects. Achieving any one of these technical effects represents exhibition of technical utility.

### DESCRIPTION OF REFERENCE CHARACTERS

TV television receiver
LDU liquid crystal display unit
PWB power board
MB main board
CTB control board
CV cover
ST stand
LU LED unit
10 liquid crystal display device
11 liquid crystal panel
12 backlight device
13 exterior frame
14 chassis
15, 115, 215, 315 optical sheet
15e, 115e, 215e, 315e tab portion
15s, 115s, 215s, 315s opening
15t, 115t, 215t, 315t flexible portion
16 light guide plate
17 LED
18 LED substrate
19 heat sink
20 reflective sheet
22 interior frame
24, 124 locking member

1. An illumination device, comprising:
a light source;
a frame member above the light source, the frame member having at least a supporting surface;
locking members, each including an upright portion that extends up from the supporting surface in a direction opposite to a side on which the light source is disposed, and a bent portion that extends, from an end of the upright portion, away from a center of the frame member and parallel to the supporting surface; and
an optical sheet that has an edge thereof supported by the supporting surface and that applies an optical effect to light from the light source, the optical sheet having openings that are formed in the edge thereof through which the upright portions of the respective locking members are inserted, and flexible portions that extend from edges of said openings such that at least part of each flexible portion overlaps with the bent portion of the corresponding locking member in a plan view, the flexible portions being flexible in a direction in which the upright portions extend.

2. The illumination device according to claim 1, wherein, among the edges of the openings, the flexible portions extend from the edge that overlaps with the bent portion of the corresponding locking member in a plan view.

3. The illumination device according to claim 2,
wherein an indentation is formed in each upright portion on a side of the upright portion that faces the corresponding flexible portion, and
wherein each of the indentations follows a shape of an end of the corresponding flexible portion.

4. The illumination device according to claim 1, wherein the openings are formed in each edge of the four-sided optical sheet.

5. The illumination device according to claim 1,
wherein protrusion-shaped tabs that extend away from a center of the optical sheet are formed along edges of said optical sheet, and
wherein the openings are formed in the respective tabs.

6. The illumination device according to claim 1,
wherein protrusion-shaped tabs that extend away from a center of the optical sheet are formed along edges of said optical sheet, and
wherein the openings are formed in the respective tabs.

7. The illumination device according to claim 1,
wherein each of the upright portions is orthogonal to the supporting surface, and
wherein each of the bent portions is orthogonal to the corresponding upright portion.

8. The illumination device according to claim 1, wherein the locking members are elastically deformable.

9. The illumination device according to claim 1, further comprising:
a light guide plate having at least one side face as a light-receiving face, and one surface as a light-exiting surface, the light guide plate being arranged such that the light-receiving face thereof faces a light-emitting surface of the light source and such that the light-exiting surface of said light guide plate faces a sheet surface of the optical sheet with a prescribed gap maintained therebetween.

10. A display device, comprising:
the illumination device according to claim 1; and
a display panel for displaying images using light from the illumination device.

11. The display device according to claim 10,
wherein the display panel is disposed on a side opposite to the supporting surface, with the optical sheet therebetween, and
wherein the frame member further includes a panel-supporting surface that supports edges of the display panel.

12. The display device according to claim 11, wherein the display panel is supported by the panel-supporting surface such that a gap is maintained between the display panel and the optical sheet.

13. The display device according to claim 10, wherein the display panel is a liquid crystal panel that uses a liquid crystal material.

14. A television receiver, comprising:
the display device according to claim 10.
